(19) United States
(12) Patent Application Publication
(10) Pub. No.: US 2014/0009378 A1
(43) Pub. Date: Jan. 9, 2014

(54) User Profile Based Gesture Recognition

(71) Applicant: Yen Hsiang Chew, Georgetown (MY)

(72) Inventor: Yen Hsiang Chew, Georgetown (MY)

(21) Appl. No.: 13/541,048

(22) Filed: Jul. 3, 2012

(51) Int. Cl. G06F 3/01

(52) U.S. Cl. 345/156

(57) ABSTRACT

An embodiment includes a system recognizing a first user via a camera, selecting a profile for the first user, and interpreting the first user's gestures according to that profile. For example, the embodiment identifies a first user, loads his gesture signature profile, and then interprets the first user forming his fist with his thumb projecting upwards as acceptance of a condition presented to the user (e.g., whether the user wishes to turn a tuner to a certain channel). The embodiment recognizes a second user, selects a profile for the second user, and interprets the second user's gestures according to that profile. For example, the embodiment identifies the second user, loads her profile, and then interprets the second user forming her fist with her thumb projecting upwards as the user pointing upwards. This moves an area of focus upwards on a graphical user interface. Other embodiments are described herein.

### BACKGROUND

A computing system, coupled to a camera and gesture recognition software, can recognize user gestures such as hand waving motions, finger positions, and facial expressions. The system may convert these gestures into computer recognizable commands based on heuristics. For example, a user may extend an index finger. The gesture recognition software may recognize the extended index finger and track that finger as the user moves his or her hand. Based on the tracking, the system may move a cursor or mouse across a graphical user interface (GUI) in line with movement of the user's index finger.

However, different users of the system may exhibit different sets of behavior to convey the same command to a computing system. Differences in user gestures may be influenced by a person's cultural, social, and/or personal background. For example, a first user may be more inclined to point with his index finger (see above) compared to a second user that, for cultural reasons, only points with his thumb. As another example, a first user may wave her hand from side to side at the elbow level to issue a command while a second user may, due to physical limitations, simply move her hand from side to side at the wrist level to issue the same command. Conventional gesture recognition systems fail to appreciate such differences in gestures and therefore complicate use of such systems for various segments of society.

### BRIEF DESCRIPTION OF THE DRAWINGS

Features and advantages of embodiments of the present invention will become apparent from the appended claims, the following detailed description of one or more example embodiments, and the corresponding figures, in which:

FIG. 1 includes a schematic flow chart in one embodiment of the invention.

FIG. 2 includes a schematic flow chart in one embodiment of the invention.

FIG. 3 includes a representative table for one embodiment of the invention.

FIG. 4 includes a system for operation with embodiments of the invention.

### DETAILED DESCRIPTION

In the following description, numerous specific details are set forth but embodiments of the invention may be practiced without these specific details. Well-known circuits, structures and techniques have not been shown in detail to avoid obscuring an understanding of this description. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

An embodiment includes a system, such as an entertainment system, recognizing a first image of a first user via a camera, selecting a corresponding first profile for the first user, and then interpreting the first user's gestures, also captured via the camera, according to that first profile. For example, the embodiment may recognize the first user's face and then load/link to a user profile for that first user. The profile may include various gesture signatures—indicators that help distinguish the first user's gestures from one another (e.g., a “thumbs up” sign from a “halt” open faced palm related sign) and possibly from gestures of another user. After loading the user profile the system may interpret the first user forming his fist with his thumb projecting upwards as acceptance of a condition/question presented to the user visually on a GUI. For example, the condition may be whether the user wishes to turn a tuner to a certain channel. The camera recognizing the user's “thumbs up” gesture may result in the system turning the tuner to the channel.

The embodiment may further include recognizing a second image of a second user via the camera, selecting a corresponding second profile for the second user, and then interpreting the second user's gestures according to that second profile. For example, the embodiment may recognize the second user's face and then load/link to a user profile for that second user. After loading the user profile the system may interpret the second user forming her fist with her thumb projecting upwards as the user pointing upwards. This may move a visual area of focus (e.g., mouse or cursor) upwards on a GUI. Thus, an embodiment implements gesture recognition as a method for interacting with a user in a user-specific way and enhances the ability for gesture recognition software to interpret a user's gesture commands. Other embodiments are described herein.

One embodiment includes a database of gesture signature profiles for one or more users of a system. Such a profile includes one or more gesture signatures. When a user logs into the system (e.g., by entering a password, username, and the like), the system searches for the corresponding user's gesture profile and loads the user's gesture signatures (e.g., a “thumbs up” gesture) into its gesture recognition software. As discussed in greater detail below, gesture signatures may be distinguished based on, for example, signature characteristics such as (1) nominal distance a user moves his hand from one position to another to issue a command, (2) nominal motion speed for a user to perform certain actions, (3) a user's facial profiles and predefined user expressions, (4) a predefined image of a user's gesture (e.g., such as a user's hand with two fingers sticking out), (5) a predefined video profile of a user's movement, such as performing a chopping motion with an open palm, and (6) any other gesture signatures that will be able to assist the gesture recognition software in identifying a user behavior based on a set of heuristics.

In one embodiment the user gesture signature profile may be generated as follows. First, a software application program interface (API) allows the user to enter his example gestures (e.g., through an integrated camera using image capture) in response to answering a set of predefined user questions. Then heuristics are used to fine tune the user's gesture signature. For example, the API may prompt the user to make the same gesture three times and then average (e.g., sum averaging, running window averaging) the measurements regarding the gesture to determine the characteristics most representative of the gesture. In other embodiments, a customized user gesture signature profile may be imported from an external source.

After the profile is generated and stored in a database, the database may be referenced whenever the user issues a gesture command to the computing system. Gesture signature interpreter software will interpret the user's gesture based on his or her user signatures to detect the most likely user command and then proceed to execute the interpreted user command. The user gesture signature profile database can be customized, as an example, for each member of a family and dynamically loaded into or referenced by gesture recognition software based on which user is currently logged into the system.

In another embodiment, for a gesture recognition system used in public areas (e.g., shopping malls, airports, train stations, and the like) a collective user gesture signature profile may be used. The collective profile may take into account the cultural and social norms of a city or place where the public system is deployed. For example, a system deployed in a United States city may be configured with a different generic user gesture profile compared to a system that is deployed in a Japanese city. In another embodiment, a user gesture profile may be dynamically referenced (or changed) based on a detected age group or gender of its current user. This usage model may be applicable to user interactive digital signage systems with camera user feedback.

Thus, conventional gesture recognition software detects and interprets a user gesture based on a set of heuristics irrespective of its collective user profile or which user is logged into the system. However, as seen above, various embodiments enhance the effectiveness of a gesture recognition system to interpret user gestures by introducing user profile-based parameters into a set of gesture recognition heuristics. Specifically, an embodiment includes a different user gesture signature profile for each potential user of a gesture recognition system. A user gesture signature profile provides user specific parameters to a set of gesture recognition heuristics to assist in interpreting a detected user gesture. A user specific gesture signature profile may be dynamically loaded or referenced based on which user is currently logged into a system. A user specific gesture signature profile may be dynamically loaded or referenced based on detected user characteristics such as age group, gender, and city.

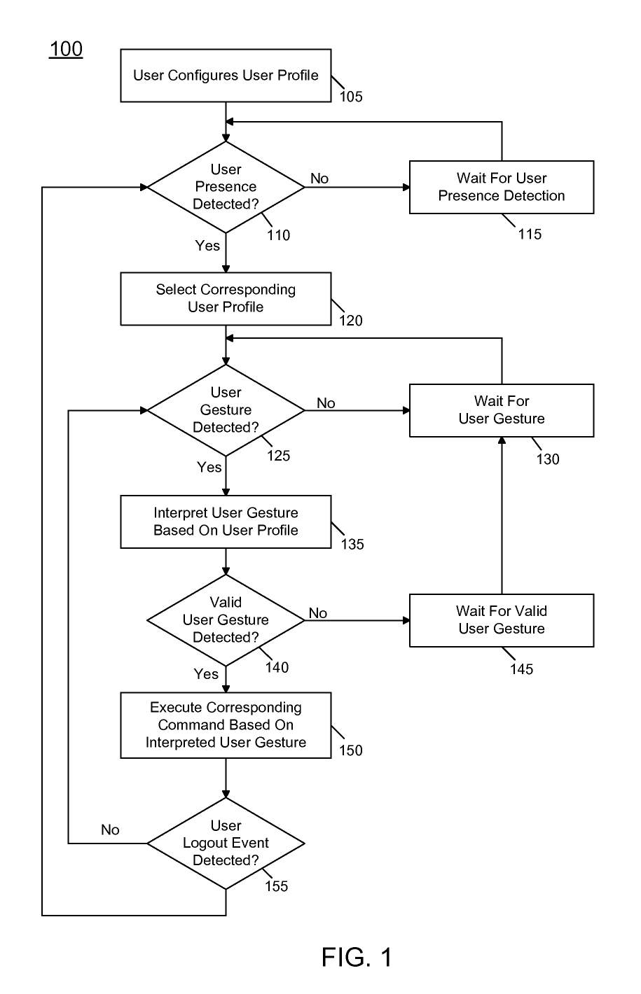

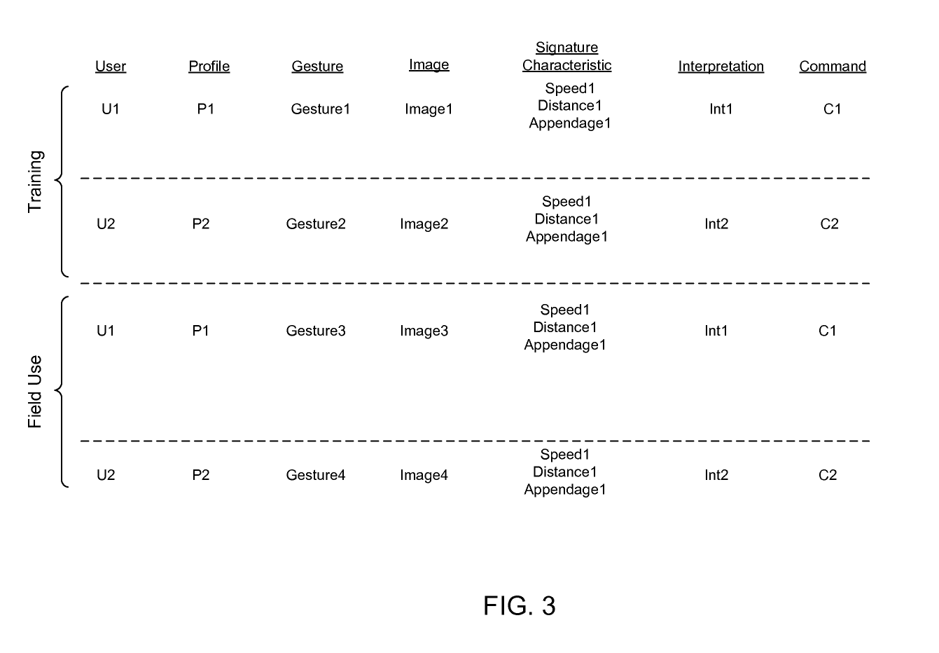

FIG. 1 includes a schematic flow chart in one embodiment of the invention. Method 100 includes block 105, where a user configures a gesture signature profile. For example, an embodiment receives initial image data corresponding to an initial gesture (from User1) in response to an initial prompt from the system. The initial prompt may include a question, statement, instruction and the like. For example, the prompt may include “Make a gesture indicating you accept or agree.” The initial prompt may be communicated to User1 orally (e.g., produced from a television or monitor speaker) or visually (e.g., displayed on a monitor). The initial image data may be an image of User1 captured by a camera coupled to the system. The initial gesture may be a “thumbs up” gesture that includes User1's right hand, clinched in a fist, with the thumb pointing up. Block 105 may include associating the initial gesture with a first gesture interpretation in User1's first user profile (explained again with regard to FIG. 3). Thus, for User1 a “thumbs up” sign or gesture is now associated with acceptance. Thus, at a later time a software API for television viewing may prompt User1 “Do you want to record this program?” to which User1 can simply flash a “thumbs up” sign to indicate the user does in fact want the program recorded. Furthermore, one embodiment receives additional image data, corresponding to an additional gesture, in response to an additional prompt from the system and associates the additional gesture with the first interpretation and the first user profile. For example, the additional prompt may include “Please repeat making a gesture indicating you accept or agree.” User1 may then flash another “thumbs up” sign or gesture. The system may then average various components from the two captured images. For example, the appendage's (thumb) orientation to the hand may be averaged to be about 90 degrees (i.e., thumb points up and hand points horizontally). In other words, the first time User1 makes the gesture the thumb may be at 89 degrees and the second time the thumb may be at 91 degrees resulting an average of 90+/−1 degrees. This may be repeated over and over as the user develops different gestures and maps those gestures to different interpretations for his profile.

The process described above for block 105 may repeat for other users. For example, in block 105 User2 configures a gesture signature profile. The embodiment receives initial image data from User2 (corresponding to an initial gesture from User2) in response to an initial prompt from the system. This time, the prompt may include “Make a gesture representative of how you point at something. This pointing will you help you direct a cursor or mouse about various graphical user interfaces.” The initial image data may be an image of User2 captured by the camera coupled to the system. The initial gesture may be a “thumbs up” gesture that includes User2's right hand, clinched in a fist, with the thumb pointing up. The configuration of block 105 may include associating the initial gesture with a second gesture interpretation and User2's second user profile. Thus, for User2 a “thumbs up” sign or gesture is not associated with acceptance (like User1) but instead is associated with pointing. Thus, at a later time a software API for television viewing may prompt User1 “Do you want to record this program?” while highlighting a certain program. User2 can simply flash a “thumbs up” sign and then relocate the highlight onto another program directed “up” (i.e., in the direction where the thumb points) from the present location of the highlight or cursor. Furthermore, User2 can “train” or customize the system in a similar manner to that of User1 by repeating the entry so the system determines an average, a standard deviation, and the like for identifying the “thumbs up” gesture for User2.

Moving on within process 100, the embodiment may select a profile, corresponding to a user, from a plurality of profiles in response to receiving a first input into a system. The first input may be a password, a login value, and/or an image of at least a portion of the user. The presence may be determined by, for example, User1 entering a password and identifier into the system. In another embodiment, User1 may be viewed by a camera of the system which compares the present image to previously stored images to determine User1 is present. Thus, in block 110 a user's presence is assessed. If no such presence is found, the process waits for user detection via block 115. However, if the image of User1 (which may constitute “first input into” the system) matches a previously stored profile image of User1 then, in block 120, the embodiment may select User1's profile from a database that includes profiles for User1, User2, and possibly others. In the present example, the camera records an image of User1, which indicates User1 is present. As a result, the User1 profile is selected (and the User2 profile is not selected).

Next, the embodiment receives first image data corresponding to a first gesture of the user and interprets the first image data and first gesture based on the selected first profile. For example, the first image data may be “thumbs up” which corresponds to a “thumbs up” entry for the User1 profile. The embodiment detects the gesture (block 125) and interprets the image (and its associated gesture) based on the User1 profile (and not the User2 profile) as an “acceptance” of a condition (block 135). If no gesture is found, the embodiment waits for such in block 130.

In block 140 the embodiment determines if the received first image is valid. In this case, the “thumbs up” image (e.g., signature characteristics such as speed, trajectory, and the like) matches a gesture interpretation associated with User1's profile. However, if that had not been the case the method would proceed along to block 145. Still, in the present example, the embodiment determines a first interpretation based on interpreting the first gesture; and issues a first command based on the first interpretation (block 150). The interpretation may simply be that the “thumbs up” for User1 is acceptance of a condition and the corresponding code instruction may be along the same lines (acceptance). Thus, if a GUI had displayed “Do you want to record the highlighted program” then the “thumbs up” would result in execution of code accepting the recording of the highlighted program.

The method may proceed to block 155 based on a log out. That log out may be, for example, User1 walking away and out of the field of capture for the camera. The log out may instead be a logout conducted via selection of a log out radio button on the GUI, and the like. If no log out occurs, the method returns to block 125. Otherwise, the method proceeds to block 110. In some embodiments, the system may log out and return to block 110 when a user's presence is no longer detected after a predetermined amount of time has elapsed (irrespective of which function block of method 100 the system is conducting).

In one embodiment, interpreting the first gesture (block 135) may be based on any combination of signature characteristics such as speed of the first gesture, distance traversed by the first gesture, trajectory of the first gesture, which of the first user's appendages is used to make the first gesture, and facial expression of the first user. For example, User1 may program his profile so when a single appendage (e.g., his thumb) projects from his hand this results in confirmation of a condition/proposition, as described above. However, when no appendage (e.g., no finger) projects from his hand this may indicate declining a condition/proposition (opposite of confirming) Furthermore, User1 may program a horizontal sweep of his hand to indicate a wish to scroll the GUI horizontally (e.g., from page to page). However, a vertical sweep of his hand may indicate a desire to scroll the GUI vertically (e.g., to move from one screen to a more general screen indicating the overall status of a system). Thus, trajectory may be of importance. Further, as indicated above, video or multi-frame sequences may constitute a gesture signature of a user profile (i.e., gesture signatures are not limited to instant pictures or images of a gesture).

The gesture may be more specific. For example, the horizontal sweep of a user's hand may need to be a certain speed. If User1 is older, this may be a slower speed. However, for a younger User1 this may be faster (to avoid registering a simple slow inadvertent sweep as an intended communication with the system). Further, a distance traversed by the hand may be a factor. For example, for an older User1 a simple six inch movement may suffice for the desired communication. However, a toddler may be prone to more dramatic movements and program the system to require a longer traversal.

In one embodiment the facial expression may be of importance. For example, the system may refuse to interpret a horizontal hand sweep as an intended communication with the system if the system does not see the user's face. Thus, if User1 is engaged in a conversation with another person and is not looking at the camera (and not intending to communicate with the system), the system will disregard the sweeping gesture. However, if User1 is staring at the screen then it is more likely the gesture was intentional and directed towards communicating with the system.

A situation may arise where User2 enters the same space as User1. In fact, User1 may leave the space and User2 may enter the space. Then, according to blocks 110, 120 the embodiment may select User2's profile and receive second image data (an image of User2 making a “thumbs up” sign) corresponding to a second gesture (User2 making a “thumbs up” sign) of User2. This may be interpreted in block 135 based on the selected User2 profile. Then in block 150 this “thumbs up” may be interpreted against the User2 profile resulting in a second command based on the interpretation. As noted above, this command may be a “pointer” directing the mouse or cursor in a direction in line with a long axis of the thumb. Thus, in this example the first gesture of User1 is generally equivalent to the second gesture of User2 (both are “thumbs up”) but the first command for User1 (confirmation) is unequal to the second command for User2 (to treat the thumb as a pointer).

In one embodiment, the selection of the User2 profile may coincide with deselecting the User1 profile based on receiving the second input (e.g., the image of User2). However, some embodiments may recognize more than one user and simultaneously allow processing of gestures from both User1 and User2. For example, with a video game User1 may use his “thumbs up” as confirmation as to whether he wants to buy more bullets for his animated gun while (e.g., simultaneously) User2 uses her “thumbs up” to aim the crosshairs of her gun at a toy animal on the games firing range.

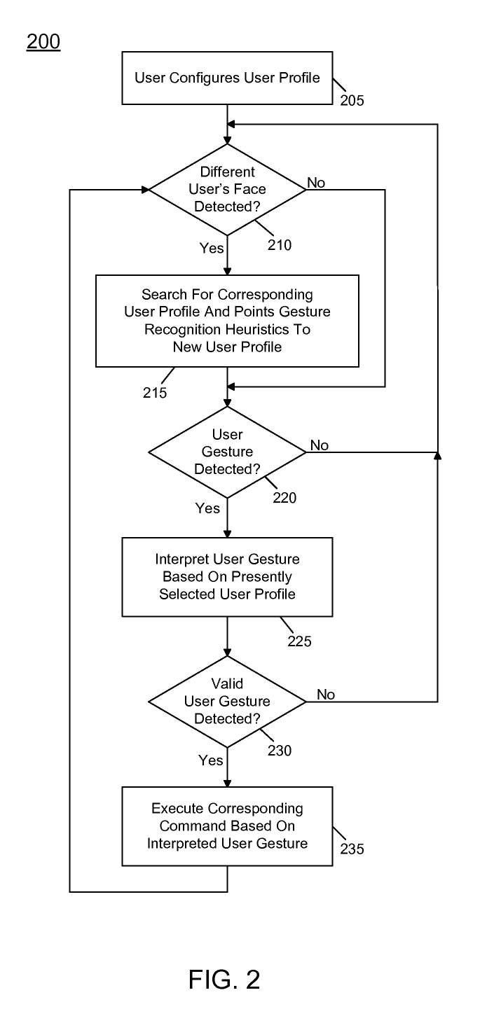

FIG. 2 includes a method 200 in an embodiment of the invention. Block 205 is analogous to block 105 of FIG. 1. However, block 210 addresses (as more fully addressed above) the situation where User1 may have previously been identified but now User2 is present and her face has been detected. In block 215 the embodiment searches for a user profile (and its corresponding gesture signatures) that matches the newly detected face (that of User2). Accordingly, rules/heuristics for how to interpret the gestures of User2 are now referenced to the profile of User2. Block 220 determines whether a gesture is detected. If not, the process returns to block 210. However, if there is such a gesture then in block 225 the gesture is interpreted based on the presently selected User2 profile. Block 230 determines if a gesture (e.g., a “thumbs up” gesture) is valid according to the User2 profile. If not, the process returns to block 210. If there is such a gesture, in block 235 a command (such as moving a mouse or highlight) is executed in association with the gesture.

In one embodiment, the user profile is not specific to any one user but instead focuses on a group of users. For example, block 110 may focus on detecting the mere presence of a female, instead of any particular person. Based on programming or, for example, global positioning system (GPS) readings for the system, the system may determine its geographic location. Thus, the system may determine it is in a location with a culture where females wear a burqa or robes that might obscure their hands, arms, facial expressions, and the like. As a result, such a system may be preprogrammed/customized to identify less refined gestures. For example, a requirement to identify a specific facial expression in order to register a gesture may be avoided if the face is not readily seen in a specific culture (e.g., when the system is located in a public place where the user may not show her face). Also, a requirement to identify a specific arm outline in order to register a gesture may be avoided if clothing (e.g., burqa or robe) may obscure the arm in a specific culture.

In one embodiment, the age of the user may help determine which profile is selected. The age may be determined via direct user input (e.g., manually typed into a terminal, spoken via voice recognition software, and the like) or determined via imaging (e.g., based on facial characteristics that help predict age such as the presence of wrinkles, the “longness” of the face, and the “softness” of contours of the face, or other factors such as the length of a person's hair, the presence of makeup (e.g., lipstick or eye-shadow) on a person's face, and/or the physical height of the user considering an adult is likely taller than children).

In yet another embodiment, more than one profile may be referenced for a user. For example, in FIG. 2 block 230 determines if a gesture (e.g., a “thumbs up” gesture) is valid according to the User2 profile. If not, the process goes to block 210. However, in an embodiment the “no” branch of block 230 may instead go to a secondary profile for guidance. Thus, if a User2 gesture is a fist moving in a circular motion, there may be no corresponding entry in the User2 profile. However, based on knowledge that the system is located in CountryY, typically associated with CultureY, a more general profile UserY may be investigated. This may include an entry corresponding to a fist moving in a circular motion and thus, block 235 may execute a command according to the command/instruction association of UserY profile. In an embodiment, instead of directing the system to a UserY profile there may be some other general profile UserX that is just a default profile not specific to any one culture, region, gender, age, or otherwise.

FIG. 3 includes a representative table for one embodiment of the invention. A method comprises receiving initial image data (Image 1), corresponding to an initial gesture (Gesture 1), in response to an initial prompt from the system; and associating the initial gesture with the first interpretation (Int 1) and the first user profile (P1) for the first user (U1). The interpretation Int 1 may be as simple as a memory address in a look up table linking to command code instruction C1. This concerns the training or programming of the gesture signature in the profile. The process can be repeated for a second user (U2) to include receiving initial image data (Image 2), corresponding to an initial gesture (Gesture 2), in response to an initial prompt from the system; and associating the initial gesture with the second interpretation (Int 2) and the second user profile (P2) for the second user (U2).

With actual field use, the method includes selecting a first profile (P1), corresponding to a first user (U1), from a plurality of profiles (P1, P2). The method further includes receiving image data (Image 3) corresponding to a gesture (Gesture 3) of the first user and interpreting the image data and the gesture, based on the selected first profile, to determine an interpretation (Int 1); and issuing a command (C1) based on the first interpretation. This can repeat for when a second user (U2) is detected. The process includes receiving image data (Image 4) corresponding to a gesture (Gesture 4) of the user (U2) and interpreting the image data and the gesture, based on the profile (P2), to determine an interpretation (Int 2); and issuing a command (C2) based on the second interpretation.

The table indicates that the interpretations are based on signature characteristics of the images. Those characteristics include, for example, speed of the gesture, distance traversed by the gesture, and the appendages shown (e.g., fingers extended) by the gesture. In FIG. 3, these characteristics are the same for each of the four gestures displayed, indicating the gestures are all very similar (e.g., they are all “thumbs up”). However, those same gestures are mapped differently. For the first profile (P1), those are interpreted as “Int 1” which links to, for example, software code such as “C1”. However, those same characteristics link to a different interpretation (Int 2) for a different profile (P2). This results in a different command (C2) being executed. FIG. 3 is merely an example of how gestures and commands are linked in a user specific way and certainly other table entries (not shown) are possible to accommodate customized gestures linked to a user of the system (e.g., Used).

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

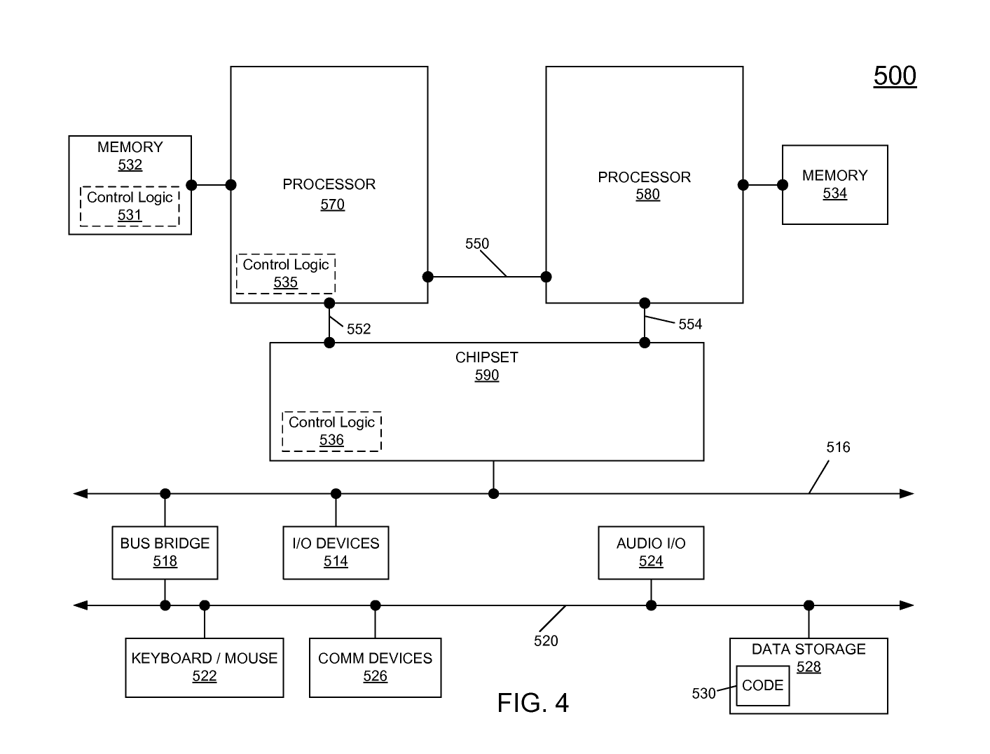

Embodiments may be implemented in many different system types. Referring now to FIG. 4, shown is a block diagram of a system in accordance with an embodiment of the present invention. Multiprocessor system 500 is a point-to-point interconnect system, and includes a first processor 570 and a second processor 580 coupled via a point-to-point interconnect 550. Each of processors 570 and 580 may be multicore processors. The term “processor” may refer to any device or portion of a device that processes electronic data from registers and/or memory to transform that electronic data into other electronic data that may be stored in registers and/or memory. First processor 570 may include a memory controller hub (MCH) and point-to-point (P-P) interfaces. Similarly, second processor 580 may include a MCH and P-P interfaces. The MCHs may couple the processors to respective memories, namely memory 532 and memory 534, which may be portions of main memory (e.g., a dynamic random access memory (DRAM)) locally attached to the respective processors. First processor 570 and second processor 580 may be coupled to a chipset 590 via P-P interconnects (552 and 554), respectively. Chipset 590 may include P-P interfaces. Furthermore, chipset 590 may be coupled to a first bus 516 via an interface. Various input/output (I/O) devices 514 may be coupled to first bus 516, along with a bus bridge 518, which couples first bus 516 to a second bus 520. The I/O devices 514 and or communication devices 526 may include one or more cameras. For example, one camera may focus on one user while another camera focuses on another user. Also, one camera may focus on a user's face while the other camera may focus on the user's appendages (e.g., fingers, arms, hands). In other embodiments a single camera, via image processing, may handle these multiple activities. Various devices may be coupled to second bus 520 including, for example, a keyboard/mouse 522, communication devices 526, and data storage unit 528 such as a disk drive or other mass storage device, which may include code 530, in one embodiment. Code may be included in one or more memories including memory 528, 532, 534, memory coupled to system 500 via a network, and the like. Further, an audio I/O 524 may be coupled to second bus 520.

Embodiments may be implemented in code and may be stored on storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Embodiments of the invention may be described herein with reference to data such as instructions, functions, procedures, data structures, application programs, configuration settings, code, and the like. When the data is accessed by a machine, the machine may respond by performing tasks, defining abstract data types, establishing low-level hardware contexts, and/or performing other operations, as described in greater detail herein. The data may be stored in volatile and/or non-volatile data storage. The terms “code” or “program” cover a broad range of components and constructs, including applications, drivers, processes, routines, methods, modules, and subprograms and may refer to any collection of instructions which, when executed by a processing system, performs a desired operation or operations. In addition, alternative embodiments may include processes that use fewer than all of the disclosed operations, processes that use additional operations, processes that use the same operations in a different sequence, and processes in which the individual operations disclosed herein are combined, subdivided, or otherwise altered. In one embodiment, use of the term control logic includes hardware, such as transistors, registers, or other hardware, such as programmable logic devices (535). However, in another embodiment, logic also includes software or code (531). Such logic may be integrated with hardware, such as firmware or micro-code (536). A processor or controller may include control logic intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like.

Any of the various memories described above may be used storing look up tables, databases, and the like to form the association between an image of a gesture and a gesture of a user profile (e.g., an association in FIG. 3 between Gesture 1 and Interpretation (Int 1)). Also, a memory such as memory 528 may be directly connected to the rest of system 500. However, such a memory may also couple to the system 500 via the cloud and may represent a distantly located server or similar storage means. Thus, instruction code, profiles belonging to User1, User2, and the like may be distributed across varying memories and accessed via the internet, wireless communication, and the like. System 500 may be included in a cell phone, personal digital assistant, tablet, Ultrabook™, laptop, notebook, desktop, mobile communications device, and the like.

Thus, one embodiment includes a method executed by at least one processor comprising: selecting a first profile, corresponding to a first user, from a plurality of profiles in response to receiving a first input into a system coupled to the at least one processor; receiving first image data corresponding to a first gesture for the first user; interpreting the first image data and first gesture, based on the selected first profile, to determine a first interpretation; and issuing a first command based on the first interpretation. In an embodiment the first input is based on one of a password, a login value, and an image of at least a portion of the first user. An embodiment includes interpreting the first gesture based on at least one of speed of the first gesture, distance traversed by the first gesture, trajectory of the first gesture, travel path of the first gesture, which of the first user's appendages is used to make the first gesture, and facial expression of the first user. Furthermore, the first gesture may be based on an external object coupled to an appendage, such as a user holding a pointing stick, remote control, and the like. The distance, trajectory, and/or path traveled by the external object may constitute a distance, trajectory, and/or path traveled by the first gesture. An embodiment includes selecting a second profile, corresponding to a second user, from the plurality of profiles in response to receiving a second input into the system; receiving second image data corresponding to a second gesture of the second user; interpreting the second image data and the second gesture, based on the selected second profile, to determine a second interpretation based on interpreting the second gesture; and issuing a second command based on the second interpretation. In an embodiment the first gesture is generally equivalent to the second gesture, the first command is unequal to the second command, and the first and second commands respectively include first and second software instructions. An embodiment includes deselecting the first profile based on receiving the second input. An embodiment includes receiving initial image data, corresponding to an initial gesture, in response to an initial prompt from the system; and associating the initial gesture with the first interpretation and the first user profile. In an embodiment (a) the initial prompt includes one of a question, a statement, and an instruction, (b) the initial prompt is communicated by one of oral and visual paths, and (c) the first image data is derived from additional image data captured via a camera. An embodiment includes receiving additional image data, corresponding to an additional gesture, in response to an additional prompt from the system; and associating the additional gesture with the first interpretation and the first user profile. In an embodiment the first input is one of a gender of the first user, age of the first user, geographic location of the first user, ethnicity of the first user, and culture of the first user. An embodiment includes selecting a second profile, corresponding to the first user, from the plurality of profiles in response to receiving the first input into the system; and attempting to interpret the first image data and first gesture based on the selected second profile and, afterwards, interpreting the first image data and first gesture based on the selected first profile. An embodiment includes interpreting the first image data and first gesture based on the selected first profile in response to failing to successfully interpret the first image data and first gesture based on the selected second profile. An embodiment includes at least one machine readable medium comprising a plurality of instructions that in response to being executed on a computing device, cause the computing device to carry out a method according to any one of the above embodiments in this paragraph. An embodiment includes an apparatus comprising means for performing any one of the above embodiments in this paragraph.

An embodiment includes an apparatus comprising: at least one memory; and at least one processor, coupled to the memory, to perform operations comprising: selecting a first profile, corresponding to a first user, from a plurality of profiles in response to receiving a first input into a system coupled to the at least one processor; receiving first image data corresponding to a first gesture for the first user; interpreting the first image data and first gesture, based on the selected first profile, to determine a first interpretation; and issuing a first command based on the first interpretation. In an embodiment the operations comprise interpreting the first gesture based on at least one of speed of the first gesture, distance traversed by the first gesture, trajectory of the first gesture, travel path of the first gesture, which of the first user's appendages is used to make the first gesture, and facial expression of the first user. Furthermore, the first gesture may be based on an external object coupled to an appendage, such as a user holding a pointing stick, remote control, and the like. In an embodiment the operations comprise: selecting a second profile, corresponding to a second user, from the plurality of profiles in response to receiving a second input into the system; receiving second image data corresponding to a second gesture of the second user; interpreting the second image data and the second gesture, based on the selected second profile, to determine a second interpretation based on interpreting the second gesture; and issuing a second command based on the second interpretation. In an embodiment the first gesture is generally equivalent to the second gesture, the first command is unequal to the second command, and the first and second commands respectively include first and second software instructions. In an embodiment the operations comprise: receiving initial image data, corresponding to an initial gesture, in response to an initial prompt from the system; and associating the initial gesture with the first interpretation and the first user profile. In an embodiment the first input is one of a gender of the first user, age of the first user, geographic location of the first user, ethnicity of the first user, and culture of the first user. In an embodiment the operations comprise: selecting a second profile, corresponding to the first user, from the plurality of profiles in response to receiving the first input into the system; and attempting to interpret the first image data and first gesture based on the selected second profile and, afterwards, interpreting the first image data and first gesture based on the selected first profile. In an embodiment the operations comprise interpreting the first image data and first gesture based on the selected first profile in response to failing to successfully interpret the first image data and first gesture based on the selected second profile.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. At least one machine readable medium comprising instructions that when executed on a computing device cause the computing device to perform a method comprising:
selecting a first profile, corresponding to a first user, from a plurality of profiles in response to receiving a first input into a system coupled to the computing device;
receiving first image data corresponding to a first gesture of the first user;
interpreting the first image data and the first gesture, based on the selected first profile, to determine a first interpretation; and
issuing a first command based on the first interpretation.

2. The at least one medium of claim 1, wherein the first input is based on one of a password, a login value, and an image of at least a portion of the first user.

3. The at least one medium of claim 1, the method comprising interpreting the first gesture based on at least one of speed of the first gesture, distance traversed by the first gesture, trajectory of the first gesture, travel path of the first gesture, which of the first user's appendages is used to make the first gesture, and facial expression of the first user.

4. The at least one medium of claim 1, the method comprising:
selecting a second profile, corresponding to a second user, from the plurality of profiles in response to receiving a second input into the system;
receiving second image data corresponding to a second gesture of the second user;
interpreting the second image data and the second gesture, based on the selected second profile, to determine a second interpretation; and
issuing a second command based on the second interpretation.

5. The at least one medium of claim 4, wherein the first gesture is generally equivalent to the second gesture, the first command is unequal to the second command, and the first and second commands respectively include first and second software instructions.

6. The at least one medium of claim 4, the method comprising deselecting the first profile based on receiving the second input.

7. The at least one medium of claim 1, the method comprising:
receiving initial image data, corresponding to an initial gesture, in response to an initial prompt from the system; and
associating the initial gesture with the first interpretation and the first user profile.

8. The at least one medium of claim 7, wherein (a) the initial prompt includes one of a question, a statement, and an instruction, (b) the initial prompt is communicated by one of oral and visual paths, and (c) the first image data is derived from additional image data captured via a camera.

9. The at least one medium of claim 7 comprising:
receiving additional image data, corresponding to an additional gesture, in response to an additional prompt from the system; and
associating the additional gesture with the first interpretation and the first user profile.

10. The at least one medium of claim 1, wherein the first input is one of a gender of the first user, age of the first user, geographic location of the first user, ethnicity of the first user, and culture of the first user.

11. The at least one medium of claim 1, the method comprising:
selecting a second profile, corresponding to the first user, from the plurality of profiles in response to receiving the first input into the system; and
attempting to interpret the first image data and the first gesture based on the selected second profile and, afterwards, interpreting the first image data and the first gesture based on the selected first profile.

12. The at least one medium of claim 11, the method comprising interpreting the first image data and the first gesture based on the selected first profile in response to failing to successfully interpret the first image data and the first gesture based on the selected second profile.

13. An apparatus comprising:
at least one memory; and
at least one processor, coupled to the memory, to perform operations comprising:
selecting a first profile, corresponding to a first user, from a plurality of profiles in response to receiving a first input into a system coupled to the at least one processor;
receiving first image data corresponding to a first gesture of the first user;
interpreting the first image data and first gesture, based on the selected first profile, to determine a first interpretation; and
issuing a first command based on the first interpretation.

14. The apparatus of claim 13, wherein the operations comprise interpreting the first gesture based on at least one of speed of the first gesture, distance traversed by the first gesture, trajectory of the first gesture, travel path of the first gesture, which of the first user's appendages is used to make the first gesture, and facial expression of the first user.

15. The apparatus of claim 13, wherein the operations comprise:
selecting a second profile, corresponding to a second user, from the plurality of profiles in response to receiving a second input into the system;
receiving second image data corresponding to a second gesture of the second user;
interpreting the second image data and the second gesture, based on the selected second profile, to determine a second interpretation based on interpreting the second gesture; and
issuing a second command based on the second interpretation.

16. The apparatus of claim 15, wherein the first gesture is generally equivalent to the second gesture, the first command is unequal to the second command, and the first and second commands respectively include first and second software instructions.

17. The apparatus of claim 13, wherein the operations comprise:
receiving initial image data, corresponding to an initial gesture, in response to an initial prompt from the system; and
associating the initial gesture with the first interpretation and the first user profile.

18. The apparatus of claim 13, wherein the first input is one of a gender of the first user, age of the first user, geographic location of the first user, ethnicity of the first user, and culture of the first user.

19. The apparatus of claim 13, wherein the operations comprise:
selecting a second profile, corresponding to the first user, from the plurality of profiles in response to receiving the first input into the system; and
attempting to interpret the first image data and the first gesture based on the selected second profile and, afterwards, interpreting the first image data and the first gesture based on the selected first profile.

20. The apparatus of claim 19, wherein the operations comprise interpreting the first image data and the first gesture based on the selected first profile in response to failing to successfully interpret the first image data and the first gesture based on the selected second profile.

21. A method executed by at least one processor comprising:
selecting a first profile, corresponding to a first user, from a plurality of profiles in response to receiving a first input into a system coupled to the at least one processor;
receiving first image data corresponding to a first gesture of the first user;
interpreting the first image data and the first gesture, based on the selected first profile, to determine a first interpretation; and
issuing a first command based on the first interpretation.

22. The method of claim 21 comprising:
selecting a second profile, corresponding to a second user, from the plurality of profiles in response to receiving a second input into the system;
receiving second image data corresponding to a second gesture of the second user;
interpreting the second image data and the second gesture, based on the selected second profile, to determine a second interpretation; and
issuing a second command based on the second interpretation.

23. The method of claim 22, wherein the first gesture is generally equivalent to the second gesture, the first command is unequal to the second command, and the first and second commands respectively include first and second software instructions.

24. The method of claim 21 comprising:
selecting a second profile, corresponding to the first user, from the plurality of profiles in response to receiving the first input into the system; and
attempting to interpret the first image data and the first gesture based on the selected second profile and, afterwards, interpreting the first image data and the first gesture based on the selected first profile.
